(19) United States
(12) Patent Application Publication
(10) Pub. No.: US 2010/0061082 A1
(43) Pub. Date: Mar. 11, 2010

(54) BACKLIGHT DEVICE AND DISPLAY APPARATUS

(76) Inventor: Keiji Hayashi, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/530,272

(22) PCT Filed: Dec. 10, 2007
(86) PCT No.: PCT/JP2007/073786

§ 371 Date: Sep. 8, 2009

(30) Foreign Application Priority Data
Apr. 13, 2007 (JP) 2007-106268

(51) Int. Cl. F21V 9/04; G02F 1/13357

(52) U.S. Cl. 362/97.1; 362/97.2

(57) ABSTRACT

A backlight device (8) includes: a blue discharge lamp (9B) and a yellow discharge lamp (9RG) whose light-emission colors are different from each other and that emit light capable of being mixed into white light. A near infrared absorbing filter (near infrared absorbing portion) (10) that absorbs near infrared light is provided on an outer circumferential portion of the discharge lamp (9RG).

### TECHNICAL FIELD

The present invention relates to a backlight device and a display apparatus using the same.

### BACKGROUND ART

Recently, in a household television receiver, for example, a display apparatus provided with a liquid crystal panel as a flat display portion with a number of features such as thinness and a light weight as compared with a conventional Broun tube, as typified by a liquid crystal display apparatus, is becoming a mainstream. Such a liquid crystal display apparatus includes a backlight device emitting light and a liquid crystal panel displaying a desired image by playing a role of a shutter with respect to light from a light source provided in the backlight device. Then, the television receiver displays information such as characters and images contained in video signals of a television broadcast on a display surface of the liquid crystal panel.

Further, the above-described backlight device is classified roughly into a direct type and an edge-light type depending on the arrangement of the light source with respect to the liquid crystal panel. A liquid crystal display apparatus having a liquid crystal panel of 20 inches or more generally uses the direct type backlight device that can achieve an increase in brightness and enlargement more easily than the edge-light type backlight device. More specifically, in the direct type backlight device, a plurality of light sources are placed on a rear side (non-display surface) of the liquid crystal panel, and the light sources can be placed right on a reverse side of the liquid crystal panel, which enables a number of light sources to be used. Thus, the direct type backlight device can obtain high brightness easily, and is suitable for an increase in brightness and enlargement. Further, the direct type backlight device has a hollow structure, and hence, is light-weight even when enlarged. This also allows the direct type backlight device to be suitable for an increase in brightness and enlargement.

In a conventional backlight device, as described in JP 2000-292767 A, for example, it has been proposed that an amount of incident light from a light-emitting surface to the liquid crystal panel is adjusted by switching on cold cathode fluorescent tubes with pulse width modulation (PWM) dimming, so that intensity (brightness) of a display surface of the liquid crystal display apparatus is controlled. That is, the conventional backlight device uses the PWM dimming that has a larger slimming range, namely a larger adjustable brightness range on the light-emitting surface than conventional current dimming, thereby providing a liquid crystal display apparatus with excellent display performance (brightness).

### DISCLOSURE OF INVENTION

### Problem to be Solved by the Invention

However, in the conventional backlight device as described above, when a current supply to the cold cathode fluorescent tubes is changed by changing an on/off duty ratio of the PWM dimming, pulse-shaped near infrared light may be emitted from the cold cathode fluorescent tubes toward the outside depending on the type of rare gas sealed in the cold cathode fluorescent tubes, the sealed amount of the gas, the current supply to the cold cathode fluorescent tubes, and the like. When such a near infrared leak occurs, there is a possibility that circumferential electric equipment is adversely affected by a near infrared noise.

More specifically, when a near infrared leak occurs in the conventional backlight device, there are possibilities that a remote controller of household electrical appliances using infrared data communication malfunctions, and that data communication using an infrared data carrier wave between information terminals such as mobile phones is inhibited, for example. In particular, when an increased number of cold cathode fluorescent tubes are provided so as to accommodate a larger screen of the liquid crystal panel, a higher level of pulse-shaped near infrared noise is generated, so that electric equipment may be adversely affected easily as described above by the conventional backlight device.

In view of the above-described problem, an object of the present invention is to provide a backlight device that can suppress a near infrared leak and prevent circumferential electrical equipment from being adversely affected by a near infrared noise, and a display apparatus using the same.

### Means for Solving Problem

In order to achieve the above-described object, a backlight device according to the present invention includes: discharge lamps of a plurality of colors whose light-emission colors are different from each other and that emit light capable of being mixed into white light; and a near infrared absorbing portion that is provided so as to be opposed to the discharge lamp of at least one light-emission color among the discharge lamps of the plurality of colors, and absorbs near infrared light emitted from the discharge lamp.

In the backlight device configured as described above, the near infrared absorbing portion is provided so as to be opposed to the discharge lamp of at least one light-emission color among the discharge lamps of the plurality of colors that emit light capable of being mixed into white light. Thus, unlike the conventional example as described above, it is possible to suppress a near infrared leak and to prevent circumferential electrical equipment from being adversely affected by a near infrared noise. Further, when the near infrared absorbing portion is provided so as to be opposed only to the discharge lamp of one light-emission color, for example, it is possible to suppress a decrease in the light utilization efficiency of the discharge lamp due to the provision of the near infrared absorbing portion, while suppressing a near infrared leak, thereby suppressing a decrease in the amount (brightness) of light to the outside.

The near infrared absorbing portion is provided so as to be opposed to the discharge lamp. Herein, the near infrared absorbing portion and the discharge lamp may be close to each other, or may be spaced away from each other.

In the above-described backlight, the near infrared absorbing portion preferably is disposed at a position that is determined relative to the discharge lamps of the plurality of colors based on its light transmission properties.

In such a case, it is possible to reliably suppress a decrease in the brightness of light to the outside and a variation in the chromaticity of the light due to the provision of the near infrared absorbing portion.

In the above-described backlight device, the discharge lamps of the plurality of colors may include a first discharge lamp that emits light containing at least light having a peak wavelength of 650 nm or more, and a second discharge lamp that mainly emits light having a peak wavelength less than 650 nm, and the near infrared absorbing portion may be provided so as to be opposed to the second discharge lamp.

In such a case, it is possible to prevent light in a red wavelength region from being absorbed significantly by the near infrared absorbing portion, thereby reliably preventing a decrease in the color purity of red.

Further, in the above-described backlight device, the discharge lamps of the plurality of colors may include a third discharge lamp that emits light containing at least light having a peak wavelength of 430 nm or less, and a fourth discharge lamp that mainly emits light having a peak wavelength exceeding 430 nm, and the near infrared absorbing portion may be provided so as to be opposed to the fourth discharge lamp.

In such a case, it is possible to prevent light in a blue wavelength region from being absorbed significantly by the near infrared absorbing portion, thereby reliably preventing a decrease in the color purity of blue.

Further, in the above-described backlight device, the discharge lamps of the plurality of colors may include a blue discharge lamp that emits light of blue, and a yellow discharge lamp that emits light of yellow. The near infrared absorbing portion may include absorbing dyes that are at least one of phthalocyanine dyes and diimonium dyes and absorb near infrared light, a binder that is made of a polyester resin and holds the absorbing dyes together, and a base material that is made of a polyethylene terephthalate resin and supports the absorbing dyes and the binder. The near infrared absorbing portion may be provided so as to be opposed to the yellow discharge lamp.

In such a case, since the near infrared absorbing portion, which is relatively likely to absorb light in a blue wavelength region, is provided so as to be opposed to the yellow discharge lamp, it is possible to reliably suppress a decrease in the brightness of light to the outside and a variation in the chromaticity of the light due to the provision of the near infrared absorbing portion.

Further, in the above-described backlight device, the near infrared absorbing portion preferably is provided on a side of an object to be irradiated with the light from the discharge lamps.

In such a case, it is possible to suppress a decrease in the light utilization efficiency of the discharge lamp and to suppress a decrease in the brightness of light to the outside, as compared with the case where the near infrared absorbing portion is provided in close proximity to the discharge lamp.

Further, a display apparatus according to the present invention uses any of the above-described backlight devices.

The display apparatus configured as described above uses the backlight device that can suppress a near infrared leak and prevent circumferential electrical equipment from being adversely affected by a near infrared noise. Thus, the display apparatus that can control a near infrared noise can be formed easily.

### EFFECTS OF THE INVENTION

According to the present invention, it is possible to provide a backlight device that can suppress a near infrared leak and prevent circumferential electrical equipment from being adversely affected by a near infrared noise, and a display apparatus using the same.

### BRIEF DESCRIPTION OF DRAWINGS

FIG. 1 is an exploded perspective view illustrating a television receiver using a liquid crystal display apparatus according to a first embodiment of the present invention.

FIG. 2 is a diagram illustrating configurations of main portions of the liquid crystal display apparatus.

FIG. 3A is an enlarged cross-sectional view of a cold cathode fluorescent tube 9RG and a near infrared absorbing filter wound around the cold cathode fluorescent tube 9RG shown in FIG. 2, and FIG. 3B is a partially enlarged cross-sectional view of a near infrared absorbing layer of the near infrared absorbing filter.

FIG. 4 is a block diagram showing a functional configuration of the liquid crystal display apparatus.

FIG. 5 is a block diagram showing a specific exemplary configuration of a controller shown in FIG. 4.

FIG. 6 is a timing chart showing an exemplary relationship among timing of switching on/off light sources in the liquid crystal display apparatus, timing of supplying a data signal to each data line, and amounts of light emitted from the light sources.

FIG. 7 is a timing chart showing another exemplary relationship among timing of switching on/off the light sources in the liquid crystal display apparatus, timing of supplying a data signal to each data line, and amounts of light emitted from the light sources.

FIG. 8 is a graph showing light transmission properties of the near infrared absorbing filter.

FIG. 9 is a NTSC chromaticity diagram (NTSC ratio) showing color reproduction ranges in the CIE 1931 color system of a comparative liquid crystal display apparatus using a three-band tube as a light source and the liquid crystal display apparatus of the present embodiment.

FIG. 10 is a diagram illustrating configurations of main portions of a liquid crystal display apparatus according to a second embodiment of the present invention.

FIG. 11 is an enlarged cross-sectional view of a cold cathode fluorescent tube 9RG and a near infrared absorbing filter shown in FIG. 10.

FIG. 12 is a view illustrating configurations of main portions of a liquid crystal display apparatus according to a third embodiment of the present invention.

FIG. 13 is an enlarged cross-sectional view of a cold cathode fluorescent tube 9RG and a near infrared absorbing filter shown in FIG. 12.

### DESCRIPTION OF THE INVENTION

Hereinafter, preferred embodiments of a backlight device and a display apparatus using the same according to the present invention will be described with reference to the drawings. It should be noted that the following description is directed to the case where the present invention is applied to a transmission-type liquid crystal display apparatus by way of example.

### First Embodiment

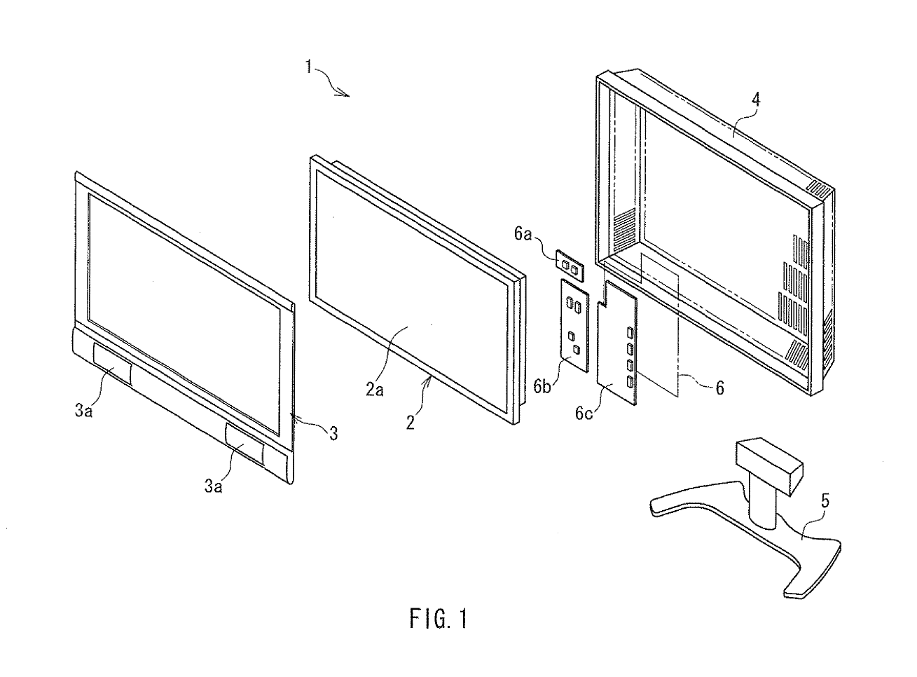

FIG. 1 is an exploded perspective view illustrating a television receiver using a liquid crystal display apparatus according to a first embodiment of the present invention. In the figure, a television receiver 1 of the present embodiment is provided with a liquid crystal display apparatus 2 as a display apparatus and is configured to be capable of receiving a television broadcast by means of an antenna, a cable (not shown), and the like. The liquid crystal display apparatus 2, housed within a front cabinet 3 and a back cabinet 4, is set upright by using a stand 5. Further, in the television receiver 1, a display surface 2a of the liquid crystal display apparatus 2 is configured to be visible via the front cabinet 3. The liquid crystal display apparatus 2 is supported by the stand 5 in such a manner that this display surface 2a is parallel to the direction of gravity (vertical direction).

In the television receiver 1, between the liquid crystal display apparatus 2 and the back cabinet 4, there also are provided a TV tuner circuit board 6a, a control circuit board 6b for controlling each portion of the television receiver 1 such as a backlight device to be described later, and a power supply circuit board 6c, which are mounted on a support plate 6. Further, in the television receiver 1, images corresponding to video signals of a television broadcast received by a TV tuner on the TV tuner circuit board 6a are displayed on the display surface 2a, while audio is reproduced and output from speakers 3a mounted on the front cabinet 3. It should be noted that a number of air holes are formed on the back cabinet 4 so as to appropriately release heat generated in the backlight device, a power source, and the like.

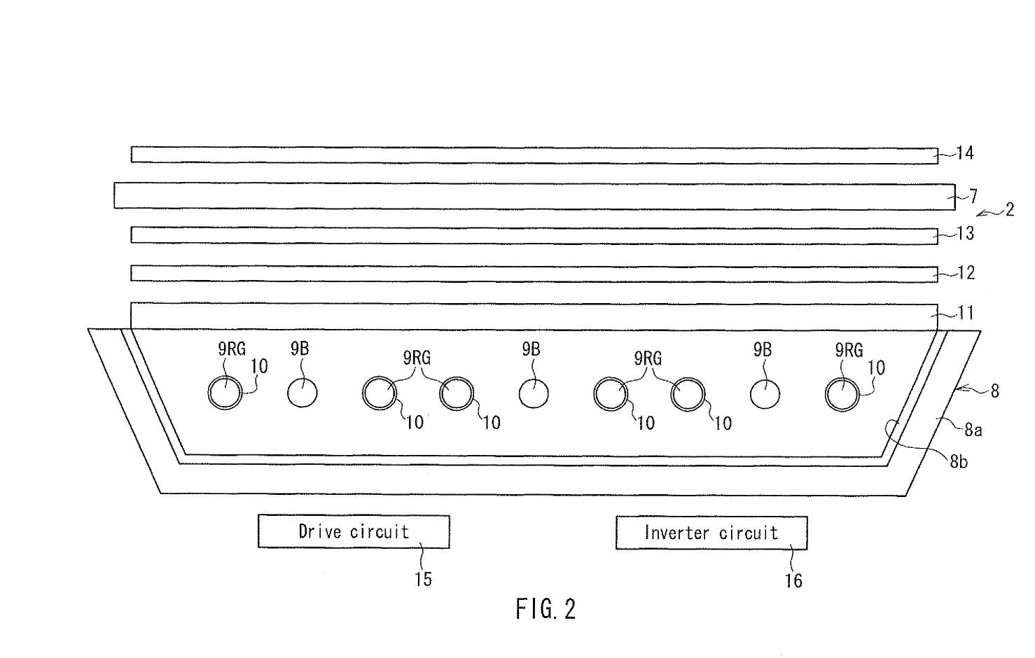

Next, the liquid crystal display apparatus 2 will be described specifically with reference to FIG. 2.

FIG. 2 is a view illustrating configurations of main portions of the liquid crystal display apparatus. In the figure, the liquid crystal display apparatus 2 includes a liquid crystal panel 7 and a backlight device 8. The liquid crystal panel 7, as a display portion, displays information such as characters and images. The backlight device 8 is disposed on a non-display surface side (lower side of the figure) of the liquid crystal panel 7 and generates illumination light to illuminate the liquid crystal panel 7. The liquid crystal panel 7 and the backlight device 8 are integrated so as to form the liquid crystal display apparatus 2 of a transmission type. In the liquid crystal display apparatus 2, a pair of polarizing plates 13 and 14 are disposed on the non-display surface side and the display surface side of the liquid crystal panel 7, respectively, in such a manner that transmission axes thereof are arranged in crossed-Nicols.

The backlight device 8 includes a bottomed casing 8a and a plurality of cold cathode fluorescent tubes 9B and 9RG (hereinafter referred to with a generic reference numeral “9”) housed in the casing 8a. On an inner surface of the casing 8a, there is provided, for example, a reflection sheet 8b that reflects light from the cold cathode fluorescent tubes 9 to the liquid crystal panel 7 side, thereby improving the light utilization efficiency of the cold cathode fluorescent tubes 9.

Each of the cold cathode fluorescent tubes 9 is straight-tube type, and electrode portions (not shown) provided at both ends thereof are supported on an outer side of the casing 8a. Further, each of the cold cathode fluorescent tubes 9 also is configured to have a small diameter of about 3.0 to 4.0 mm so as to have excellent light-emission efficiency. Each of the cold cathode fluorescent tubes 9 is held inside the casing 8a with a light source holder (not shown) while distances from each of the cold cathode fluorescent tubes 9 to a diffusion plate 11 and to the reflection sheet 8b are kept at predetermined distances. Furthermore, the cold cathode fluorescent tubes 9 are arranged so that the longitudinal direction thereof is parallel to a direction perpendicular to the direction of gravity. This arrangement can prevent mercury (vapor) sealed in each of the cold cathode fluorescent tubes 9 from being concentrated at one end of the cold cathode fluorescent tube 9 in the longitudinal direction due to the action of gravity, resulting in significantly improved lamp life.

In the cold cathode fluorescent tubes 9B, a blue phosphor (for example, NP-103 manufactured by Nichia Corporation) is sealed so that an emission spectrum has a peak in a wavelength region of blue (for example, in the vicinity of 447 nm), thereby constituting a first light source that emits light of blue as light of a first color.

On the other hand, in the cold cathode fluorescent tubes 9RG, red and green phosphors (for example, NP-320 and NP-108 manufactured by Nichia Corporation) are sealed so that an emission spectrum has peaks in a wavelength region of red (for example, in the vicinity of 658 nm) and in a wavelength region of green (for example, in the vicinity of 516 nm), thereby constituting a second light source that emits light of red and green (light of yellow) as light of a second color.

As shown in FIG. 2 as an example, the backlight device 8 includes three cold cathode fluorescent tubes 9B and six cold cathode fluorescent tubes 9RG. They are arranged in such a manner that two juxtaposed cold cathode fluorescent tubes 9RG are placed in each space between two adjacent cold cathode fluorescent tubes 9B so as to make an alternate arrangement of the cold cathode fluorescent tubes 9B and 9RG. These cold cathode fluorescent tubes 9B and 9RG are arranged so that the longitudinal direction thereof is parallel to an extending direction of scanning lines of the liquid crystal panel 7 and so as to keep equal distances respectively. By providing the plurality of cold cathode fluorescent tubes 9B and 9RG as described above, the backlight device 8 having high brightness can be formed easily. Further, the alternate arrangement of the cold cathode fluorescent tubes 9B and 9RG makes it easier to prevent the luminous quality from declining, as compared with the case where the cold cathode fluorescent tubes 9B and 9RG are arranged in respective groups.

Besides the configuration as described above, the cold cathode fluorescent tubes 9B and the cold cathode fluorescent tubes 9RG may be arranged so as to alternate with each other one by one. Alternatively, the cold cathode fluorescent tubes 913 and the cold cathode fluorescent tubes 9RG may be arranged so as to alternate with each other in sets of a plural number (for example, two) of the cold cathode fluorescent tubes 9B and 9RG.

The number of the cold cathode fluorescent tubes 9 can vary appropriately in accordance with the screen size of the liquid crystal display apparatus 2, the brightness of each fluorescent tube, a desired color balance, and the like. As one example, in the case where the liquid crystal display apparatus 2 has a screen size of a so-called 37V type and uses, as described above, the cold cathode fluorescent tubes 9B having an emission peak in blue (in the vicinity of 447 nm) and the cold cathode tubes 9RG having peaks in red (in the vicinity of 658 nm) and in green (in the vicinity of 516 nm), in order to realize a white display, it is preferable to have a configuration that includes about eighteen cold cathode fluorescent tubes in total consisting of six cold cathode fluorescent tubes 9B and twelve cold cathode fluorescent tubes 9RG.

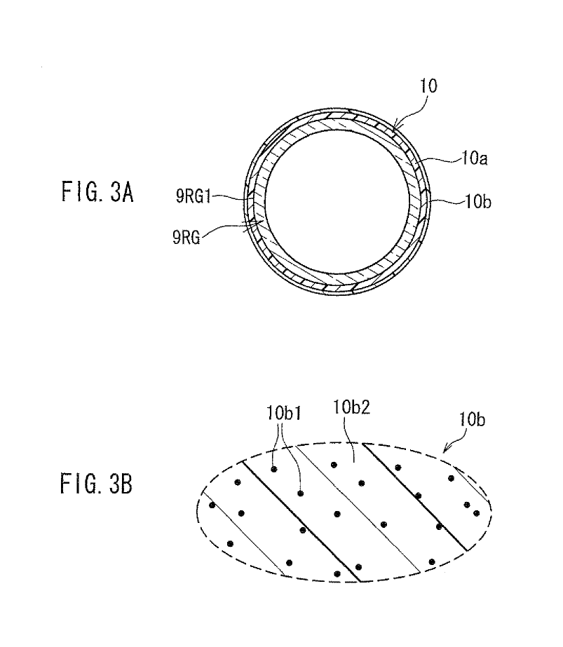

Each of the plurality of cold cathode fluorescent tubes 9RG is provided with a near infrared absorbing filter 10 as a near infrared absorbing portion that absorbs near infrared light. More specifically, as shown in FIG. 3A, the near infrared absorbing filter 10 includes a base material 10a and a near infrared absorbing layer 10b that is formed on one surface of the base material 10a to absorb near infrared light.

The base material 10a is formed of a transparent resin film such as a polyethylene terephthalate (PET) resin film. As shown in FIG. 3B, the near infrared absorbing layer 10b includes absorbing dyes 10b1 that practically absorb near infrared light, and a binder 10b2 that holds the absorbing dyes 10b1 together. The absorbing dyes 10b1 are transparent, gray, or pale yellow compounds that transmit light in a visible light region relatively well, such as at least one of phthalocyanine dyes and diimonium dyes. The binder 10b2 is made of a transparent material that holds parades of the absorbing dyes 10b1 together, such as a polyester resin and preferably, a polyester resin of a terephthalic acid or isophthalic acid copolymer type. Specific thickness dimensions of the base material 10a and the near infrared absorbing layer 10b are about 300 μm and 50 μm, respectively.

Further, all the resin and compound contained in the near infrared absorbing filter 10 exhibit light absorption properties in a wavelength region of 430 nm or less, though at a low level. Thus, in particular, when a light source (for example, a Xe discharge tube) having a peak wavelength of 430 nm or less is used as a discharge lamp (third discharge lamp), and then the near infrared absorbing filter 10 is provided in close proximity to this discharge lamp, a blue light-emitting component is lost, leading to a decrease in the color purity of blue, and a white balance of a display is lost, resulting in difficulty in adjusting (mixing) white. On this account, it is preferable not to provide the near infrared absorbing filter 10 at a position facing the third discharge lamp that emits light having a peak wavelength of 430 nm or less, but to provide the near infrared absorbing filter 10 so as to be opposed to a discharge lamp (fourth discharge lamp) that mainly emits light having a peak wavelength exceeding 430 nm.

The absorbing dyes 10b1 start absorbing light gradually from a wavelength region of 650 nm or more. Thus, when the discharge lamp (first discharge lamp) having a peak wavelength of 650 nm or more is used as a light source (for example, when a cold cathode fluorescent tube in which NP-320 manufactured by Nichia Corporation is included in a phosphor layer is used), the absorbing dyes 10b1 absorb a considerable quantity of red light, which leads to a decrease in the color purity of red. On this account, it is preferable not to provide the near infrared absorbing filter 10 at a position facing the first discharge lamp that emits light having a peak wavelength of 650 nm or more, but to provide the near infrared absorbing filter 10 so as to be opposed to a discharge lamp (second discharge lamp) that mainly emits light having a peak wavelength less than 650 nm.

In the near infrared absorbing filter 10, the base material 10a is wound around an outer circumferential surface of the cold cathode fluorescent tube 9RG (outer surface of a lamp tube wall) so as to cover an effective light-emitting portion of the cold cathode fluorescent tube 9RG, while supporting the near infrared absorbing layer 10b that includes the absorbing dyes 10b1 and the binder 10b2. In the backlight device 8, even when pulse-shaped near infrared light is emitted from the cold cathode fluorescent tubes 9B and 9RG to the outside by changing a current supply to the cold cathode fluorescent tubes 9B and 9RG in accordance with a dimming command signal to be described later, the near infrared absorbing filter 10 absorbs at least near infrared light from the cold cathode fluorescent tubes 9RG, thereby suppressing a near infrared leak to the outside of the backlight device 8.

Further, the near infrared absorbing filter 10 is provided so as to be opposed only to the cold cathode fluorescent tubes 9RG of the two types of cold cathode fluorescent tubes 9B and 9RG in light of its light transmission properties. Thus, in the backlight device 8, it is possible to reliably suppress a decrease in the brightness of illumination light and a variation in the chromaticity of the light (as described later in detail).

Returning to FIG. 2, on the outer side of the casing 8a, there are provided a drive circuit 15 that drives the liquid crystal panel 7, and an inverter circuit 16 that switches on each of the plurality of cold cathode fluorescent tubes 9 at high frequency with an inverter. Both the drive circuit 15 and the inverter circuit 16 are mounted on the control circuit board 6b (FIG. 1) and disposed so as to be opposed to the outer side of the casing 8a. The inverter circuit 16 is configured to switch on the cold cathode fluorescent tubes 9B and 9RG alternately (as described later in detail).

Further, the backlight device 8 includes a diffusion plate 11 that is disposed so as to cover an opening of the casing 8a, and an optical sheet 12 that is disposed above the diffusion plate 11. The diffusion plate 11 is made of, for example, a rectangular-shaped synthetic resin or glass material having a thickness of about 2 mm, and is configured to diffuse and emit light from the cold cathode fluorescent tubes 9 (including light reflected from the reflection sheet 8b) to the optical sheet 12 side. The diffusion plate 11 is held movable on the casing 8a, so that even when elastic (plastic) deformation occurs on the diffusion plate 11 under the influence of heat, caused by heat generation of the cold cathode fluorescent tubes 9, temperature rise inside the casing 8a, and the like, the diffusion plate 11 can absorb such deformation by moving on the casing 8a.

The optical sheet 12 includes a diffusion sheet formed of, for example, a synthetic resin film having a thickness of about 0.5 mm, and is configured to improve the display quality on the display surface of the liquid crystal panel 7 by diffusing the above illumination light toward the liquid crystal panel 7 appropriately. Further, on the optical sheet 12, commonly-known optical sheet materials such as a prism sheet and a polarizing sheet are laminated suitably as required for the purpose of, for example, improving the display quality on the display surface of the liquid crystal panel 7. The optical sheet 12 is configured to convert plane-shaped light output from the diffusion plate 11 into plane-shaped light having an almost uniform brightness not lower than a predetermined, brightness (for example, 10000 cd/m²) and make it incident as illumination light on the liquid crystal panel 7. Besides the configuration as described above, for example, optical members such as a diffusion sheet for adjusting a viewing angle of the liquid crystal panel 7 may be laminated suitably above the liquid crystal panel 7 (on the display surface side).

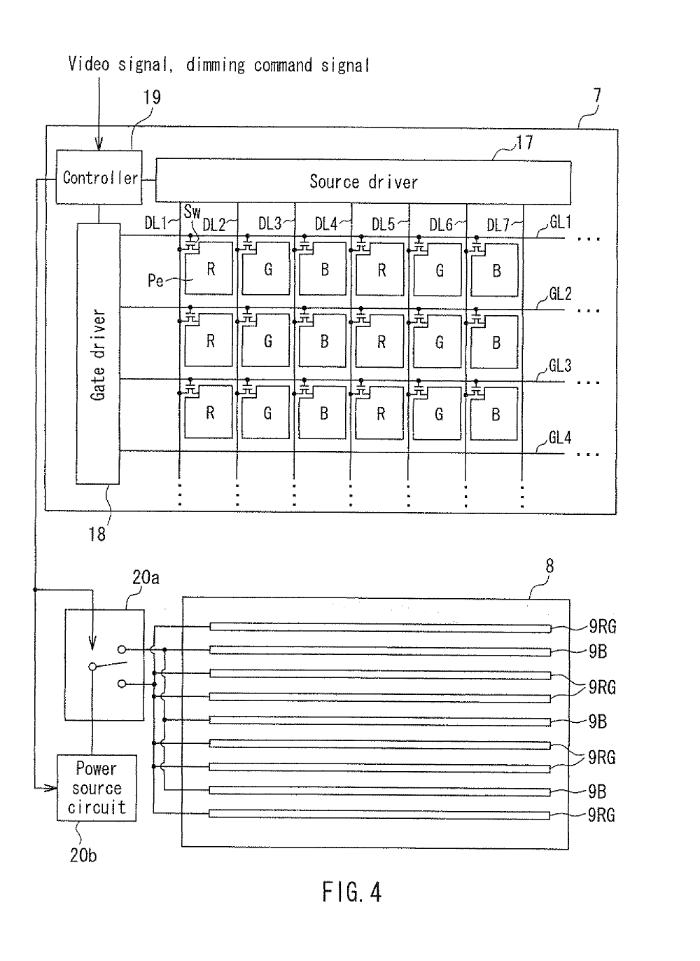

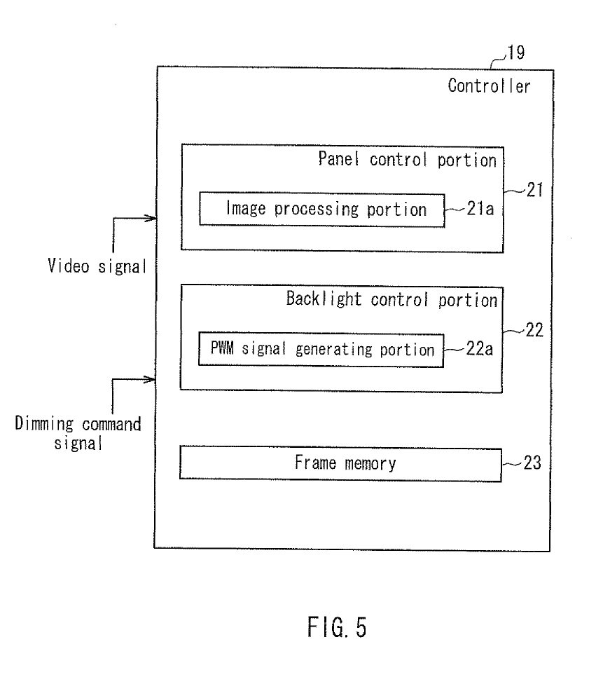

In the following, the configurations of the liquid crystal panel 7 and the backlight device 8 in the liquid crystal display apparatus 2 and methods of driving them will be described in more detail with reference to FIGS. 4 and 5. FIG. 4 is a diagram schematically showing a functional relationship between the liquid crystal panel 7 and the backlight device 8, but is not intended to faithfully represent the physical sizes of the liquid crystal panel 7 and the backlight device 8.

The liquid crystal panel 7 is a liquid crystal display element of an active matrix type, and is provided with a plurality of scanning lines GL1, GL2, GL3, (hereinafter referred to with a generic reference numeral “GL”) and a plurality of data lines of DL1, DL2, DL3, (hereinafter referred to with a generic reference numeral “DL”) formed in matrix as shown in FIG. 4, thin film transistors (hereinafter referred to as “TFT”) Sw as switching elements disposed at intersections of the scanning lines GL and the data lines DL, and pixel electrodes Pe connected to drain electrodes of the TFTs Sw.

Further, the liquid crystal panel 7 includes a gate driver 18 that sequentially supplies a selection signal to the scanning lines GL, a source driver 17 that supplies a data signal to each of the data lines DL, and a controller 19 that supplies a dock signal, a timing signal, and the like to the source driver 17, the gate driver 18, and the like. The source driver 17, the gate driver 18, and the controller 19 are included in the drive circuit 15 (FIG. 2).

Further, the liquid crystal display apparatus 2 includes a switch circuit 20a that controls switching on/off of the cold cathode fluorescent tubes 9B and 9RG of the backlight device 8 in accordance with, for example, the timing signal supplied from the controller 19. The switch circuit 20a controls switching on/off of the cold cathode fluorescent tubes 9B and 9RG through ON/OFF of a voltage supply from a power source circuit 20b or the like to the cold cathode fluorescent tubes 9B and 9RG. Further, the switch circuit 20a is included in the inverter circuit 16 (FIG. 2) and configured so that ON/OFF of all the three cold cathode fluorescent tubes 9B are controlled simultaneously, and ON/OFF of all the six cold cathode fluorescent tubes 9RG also are controlled simultaneously.

The configurations of the drivers and controller shown in FIG. 4 are merely illustrative, and modes of mounting these driving system circuits are arbitrary. For example, these driving system circuits may be provided so that at least a part of them is formed monolithically on an active matrix substrate; they may be mounted as semiconductor chips on a substrate; or alternatively, they may be connected as external circuits of the active matrix substrate. Further, the switch circuit 20a may be provided on either of the liquid crystal panel 7 or the backlight device 8.

On a counter substrate (not shown) opposed to this active matrix substrate, color filters of three colors of RGB are formed in stripes. In FIG. 4, colors of the color filters corresponding respectively to pixels are denoted by characters “R”, “G”, and “B”. Thus, as shown in FIG. 4, all of pixels in one column connected to the same data line DL display one of the RGB colors. For example, in FIG. 4, all of pixels connected to the data line DL1 display red. Although the color filters described herein are in a stripe arrangement, other types of arrangements such as a delta arrangement also may be adopted. Further, in the liquid crystal panel 7, a set of pixels corresponding respectively to the RGB colors realizes a white display.

In the liquid crystal panel 7 configured as described above, when a gate pulse (selection signal) at a predetermined voltage is applied sequentially to the scanning lines GL1, GL2, GL3, GL4, . . . , the TFT Sw connected to one of the scanning lines GL, to which the gate pulse has just been applied, is brought to an ON state, and a value of a gradation voltage that has been applied to a corresponding one of the data lines DL at that point in time is written into each of the TFTs Sw. Consequently, a potential of the pixel electrode Pe connected to a drain electrode of each of the TFTs Sw becomes equal to the value of the gradation voltage of the corresponding one of the data lines DL. As a result, an alignment of liquid crystal interposed between the pixel electrode Pe and the above opposing electrode changes in accordance with the value of the gradation voltage, and thus a gradation display of the pixel is realized. On the other hand, during a time period in which a non-selection voltage is applied to the scanning lines GL, the TFTs Sw are brought to an OFF state, so that the potential of the pixel electrode Pe is maintained at a value of a potential applied thereto at the time of writing.

As shown in FIG. 5, the controller 19 includes a panel control portion 21 that controls driving of the liquid crystal panel 7, a backlight control portion 22 that controls driving of the backlight device 8, and a frame memory 23 that is configured to be able to store display data in frame units contained in video signals input via an antenna (not shown) and the like.

Further, the panel control portion 21 includes an image processing portion 21a that controls driving of the liquid crystal panel 7 on the pixel basis by using the input video signals. The image processing portion 21a is configured to output a command signal, such as the timing signal, to the source driver 17 and the gate driver 18 in accordance with the input video signals. The image processing portion 21a determines the magnitude of the data signal (graduation voltage) on the pixel basis based on the input video signals, and incorporates the determined value into the command signal to be output to the source driver 17.

The backlight control portion 22 includes a PWM signal generating portion 22a that switches on the cold cathode fluorescent tubes 9 by using PWM dimming. The backlight control portion 22 is configured to receive the dimming command signal for instructing a variation in the brightness of the illumination light from a remote controller provided in the television receiver 1, for example. In the backlight control portion 22, the PWM signal generating portion 22a determines an on/off duty ratio of the PWM dimming between an on time period and an off time period in a PWM cycle based on the input dimming command signal, and generates and outputs a command signal to the power source circuit 19b in accordance with the determined on/off duty ratio, so that a power supply to the cold cathode fluorescent tubes 9 of the backlight device 8 is controlled. Further, the backlight control portion 22 generates and outputs a timing signal and the like to the switch, circuit 20a in accordance with one frame time period in the liquid crystal panel 7, thereby, for example, switching on only the cold cathode fluorescent tubes 9B at a first half of the one frame time period, and switching on only the cold cathode fluorescent tubes 9RG at a latter half thereof.

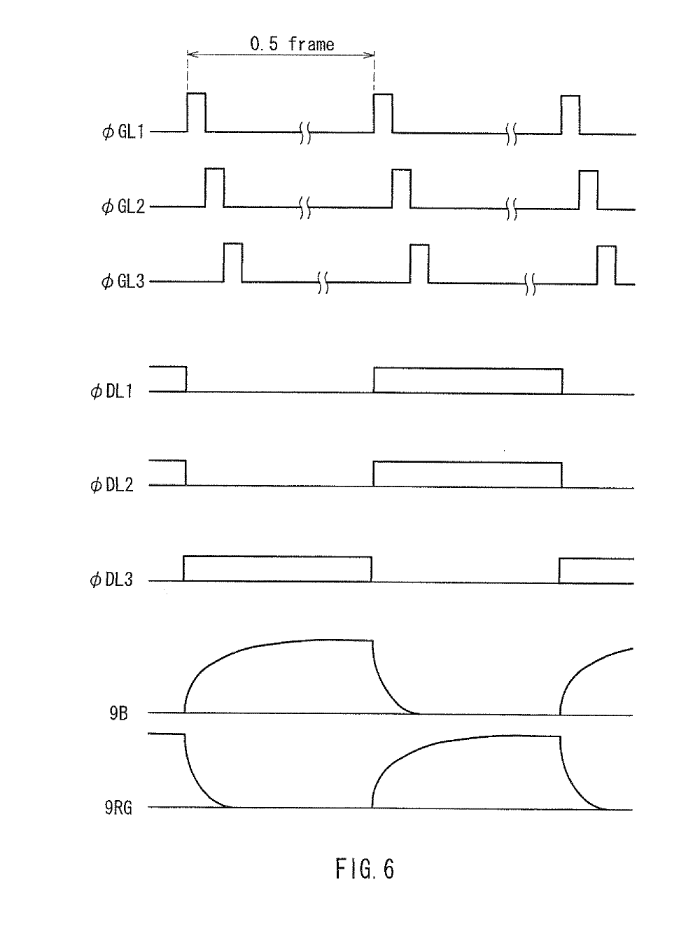

In the liquid crystal display apparatus 2 of the present embodiment configured as described above, as shown in FIG. 6, the gate driver 18 applies the gate pulse to each of the scanning lines GL at a cycle of ½ of a time period (one frame time period) in which one image is displayed in the liquid crystal panel 7. Then, at the first half of this one frame time period, the switch circuit 20a switches on the cold cathode fluorescent tubes 9B that emit light of blue while switching off the cold cathode fluorescent tubes 9RG. Further, at the latter half of the one frame time period, the switch circuit 20a switches off the cold cathode fluorescent tubes 9B while switching on the cold cathode fluorescent tubes 9RG that emit light of yellow (red and green). In FIG. 6, the first and second graphs from the bottom show amounts of light emitted from the cold cathode fluorescent tubes 9B and 9RG, respectively.

Further, at the first half of the one frame time period, the source driver 17 supplies the data signal to be applied to a pixel of blue to each of the data lines DL3, DL6, DL9, . . . that are connected to a group of pixel electrodes Pe among the pixel electrodes Pe that corresponds to the blue color filter. Thus, at the first half of the one frame time period, only a portion constituted of pixels of blue in one image is displayed.

Furthermore, at the latter half of the one frame time period, the source driver 17 supplies the data signal to be applied to a pixel of red to each of the data lines DL1, DL4, DL7, . . . that are connected to a group of pixel electrodes Pe among the pixel electrodes Pe that corresponds to the red color filter, and supplies the data signal to be applied to a pixel of green to each of the data lines DL2, DL5, DL8, . . . that are connected to a group of pixel electrodes Pe among the pixel electrodes Pe that corresponds to the green color filter. Thus, at the latter half of the one frame time period, only portions constituted of pixels of red and pixels of green in one image are displayed.

Besides the configuration as described above, portions constituted of pixels of red and pixels of green in one image may be displayed at the first half of the one frame time period, while a portion constituted of pixels of blue in one image may be displayed at the latter half thereof.

For example, in the case where the data signal is a video signal according to the NTSC standards, the refreshing rate is 60 Hz and the length of one frame time period is 16.7 milliseconds. Therefore, in the case where only a portion constituted of pixels of blue is displayed at the first half of one frame time period, and portions constituted of pixels of red and pixels of green are displayed at the latter half thereof as described above, due to the persistence of vision, a resulting image is recognized to the human eye as an image in which three primary colors are mixed.

At the first half of the one frame time period, while the cold cathode fluorescent tubes 9B that emit light of blue are switched on, the data signal supplied to each of the data lines DL1, DM, DL7, . . . that are connected to the group of pixel electrodes Pe among the pixel electrodes Pe that corresponds to the red color filter and the data signal supplied to each of the data lines DL2, DL5, DL8, . . . that are connected to the group of pixel electrodes Pe among the pixel electrodes Pe that corresponds to the green color filter may be maintained at a value of a potential applied in an immediately preceding frame or may have a predetermined potential value. However, it is preferable that these data signals have such a potential value as to cause a black gradation display. This is preferable because the black gradation display allows unwanted leakage light from a pixel portion to be blocked. The following describes reasons why leakage light as described above is generated.

One possible reason is that an ON/OFF signal of the inverter circuit 16 of the cold cathode fluorescent tubes 9 is delayed or dull. That is, when the switching on/off by the switch circuit 20a is controlled depending on whether the switching is performed at the first half or the latter half of one frame time period, if the ON/OFF signal is delayed or dull, there occurs a deviation of timing at which the cold cathode fluorescent tubes 9 actually are switched ON/OFF. Because of this, for example, at an early stage of the first half of the frame, due to light from the cold cathode fluorescent tubes 9RG that are supposed to have been switched off, leakage light from the pixels of red and green may be generated, though in a small amount. Further, reasons other than the above-described reason include an ON/OFF delay of the cold cathode fluorescent tubes 9. Specifically, the cold cathode fluorescent tube 9 has a characteristic that an amount of light emitted thereby does not immediately change in response to the control of switching on/off. For example, as shown in FIG. 6, when the switching on/off by the switch circuit 20a is controlled depending on whether the switching is performed at the first half or the latter half of one frame time period, an amount of light emitted from either of the cold cathode fluorescent tube 9B and the cold cathode fluorescent tube 9RG that is thereby being switched off does not become zero immediately after the switching by the switch circuit 20a. Because of this, for example, at an early stage of the first half of the frame, due to light from the cold cathode fluorescent tubes 9RG that are supposed to have been switched off, leakage light from the pixels of red and green may be generated, though in a small amount.

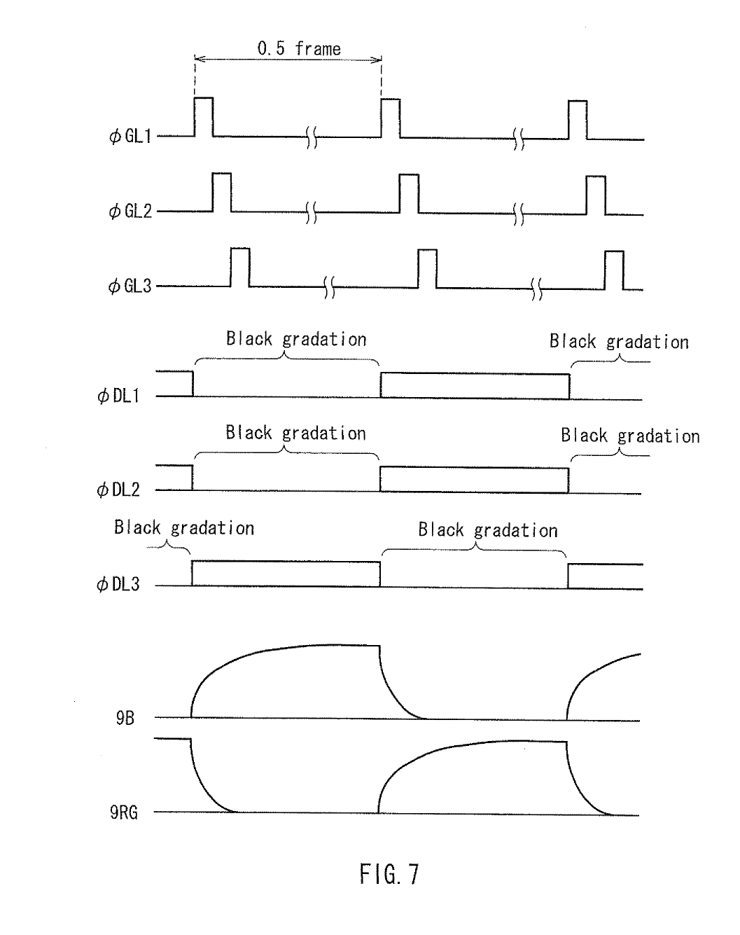

In such a case, as shown in FIG. 7, at the first half of one frame time period, the data signal having such a potential value as to cause the black gradation display is applied to each of the data lines DL1, DL4, DL7, . . . that are connected to the group of pixel electrodes Pe among the pixel electrodes Pe that corresponds to the red color filter and to each of the data lines DL2, DL5, DL8, . . . that are connected to the group of pixel electrodes Pe among the pixel electrodes Pe that corresponds to the green color filter, and thus the generation of such leakage light can be prevented, thereby allowing further improved color purity to be obtained. For the same reason, it is preferable that, at the latter half of the one frame time period, the data signal having such a potential value as to cause the black gradation display is supplied to each of the data lines DL3, DL6, DL9, . . . that are connected to the group of pixel electrodes Pe among the pixel electrodes Pe that corresponds to the blue color filter.

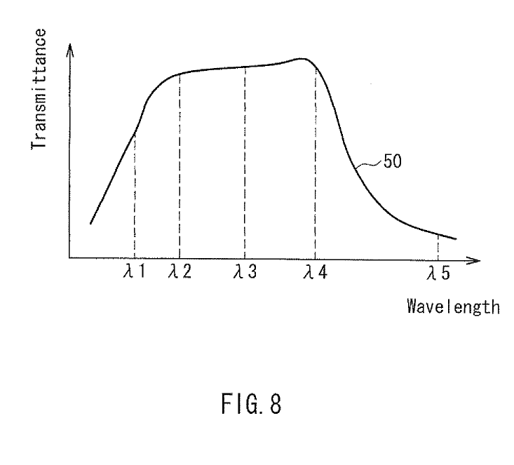

Next, the operation of the near infrared absorbing filter 10 will be described specifically with reference to FIG. 8.

As shown by a curve 50 in FIG. 8 by way of example, the near infrared absorbing filter 10 is set to have a transmittance of 70% or more with respect to visible light in a wavelength region of λ1 to λ4 shown in the figure. More specifically, the near infrared absorbing filter 10 has a transmittance of 70% to 80% with respect to light in a blue wavelength region (wavelength λ1: 380 nm to wavelength λ2: 480 nm), a transmittance of 80% to 90% with respect to light in a green wavelength region (wavelength λ2 to wavelength λ3: 580 nm), and also a transmittance of 80% to 90% with respect to light in a red wavelength region (wavelength λ3 to wavelength λ4: 780 nm).

On the other hand, the near infrared absorbing filter 10 has a transmittance of 15% or less with respect to light in a wavelength region of near infrared light, particular, light in a wavelength region (wavelength λ5: 940 nm to about 1020 nm) that is likely to be emitted from the cold cathode fluorescent tube 9 to the outside.

As described above, the near infrared absorbing filter 10 is configured to transmit 70% or more of visible light contained in light emitted from the cold cathode fluorescent tube 9RG, and to significantly absorb near infrared light having a wavelength of about 940 nm. Further, the near infrared absorbing filter 10 absorbs not only near infrared light emitted from the cold cathode fluorescent tube 9RG on which this near infrared absorbing filter 10 is mounted, but also near infrared light emitted from the neighboring, for example, adjacent cold cathode fluorescent tube 9RG.

In the backlight device 8 of the present embodiment configured as described above, among the cold cathode fluorescent tubes (discharge lamps) 9B and 9RG that emit light capable of being mixed into white light, the near infrared absorbing filter (near infrared absorbing portion) 10 is mounted on the outer circumferential surface of each of the cold cathode fluorescent tubes 9RG so as to cover the effective light-emitting portion of this cold cathode fluorescent tube 9RG. Therefore, unlike the conventional example as described above, the backlight device 8 of the present embodiment can suppress a near infrared leak even when an increased number of the cold cathode fluorescent tubes 9 are provided so as to accommodate a larger screen of the liquid crystal panel 7. As a result, the backlight device 8 of the present embodiment can prevent circumferential electrical equipment from being adversely affected by a near infrared noise even when an increased number of the cold cathode fluorescent tubes 9 are provided.

Further, the liquid crystal display apparatus 2 of the present embodiment uses the backlight device 8 that can suppress a near infrared leak and prevent circumferential electrical equipment from being adversely affected by a near infrared noise. Thus, the liquid crystal display apparatus 2 that can control a near infrared noise can be formed easily.

Further, in the backlight device 8 of the present embodiment, as shown in FIG. 2, the near infrared absorbing filter 10 that is relatively likely to absorb light in a blue wavelength region as shown by the curve 50 in FIG. 8 by way of example is mounted only on the cold cathode fluorescent tube 9RG. Thus, the backlight device 8 of the present embodiment can suppress a decrease in the light utilization efficiency of the cold cathode fluorescent tube 9B due to the provision of the near infrared absorbing filter 10, while suppressing a near infrared leakage, thereby reliably suppressing a decrease in the brightness of the illumination light and a variation in the chromaticity of the light.

Further, in the liquid crystal display apparatus 2 of the present embodiment, the backlight device 8 includes the cold cathode fluorescent tubes 9B and 9RG, which emit light of blue and light of red and green, respectively, which are complementary to each other. Further, in the liquid crystal display apparatus 2, light of blue and light of red and green are emitted at the first half and the latter half of the one frame time period, respectively, and information is displayed only with a portion constituted of corresponding pixels of blue and portions constituted of corresponding pixels of red and green at the first half and the latter half of the one frame time period. Therefore, unlike a comparative product (conventional product) that uses only cold cathode fluorescent tubes that emit light of white, the liquid crystal display apparatus 2 of the present embodiment is capable of improving color purity and corresponding with high-quality display of moving images.

Hereinafter, the above-described effects provided by the configuration of the present embodiment will be described specifically.

The above-mentioned comparative product, which uses a three-band tube or a four-band tube as a light source for the backlight device, has presented a problem that a blue component is mixed into a pixel that is to be displayed in green, and a green component is mixed into a pixel that is to be displayed in blue. This is caused by the fact that a spectral transmission curve of a blue color filter partially overlaps a wavelength region of green, and a spectral transmission curve of a green color filter partially overlaps a wavelength region of blue. Particularly, the human eye has high sensitivity to a wavelength component of green, so that an adverse effect exerted on the image quality when a green component is mixed into a pixel of blue has been recognized to be considerable.

With respect to this problem, in the configuration of the present embodiment, when displaying pixels corresponding to the blue color filter, only the cold cathode fluorescent tubes 9B that do not have a wavelength component of green are switched on, and thus even though a spectral transmission curve of the blue color filter partially overlaps a wavelength region of green, there is no possibility that an emission spectrum occurs in the wavelength region of green, thereby preventing the occurrence of color mixing. This achieves an improvement in color purity.

Particularly, as shown in FIG. 7, since the pixels of red and green are set so as to perform the black gradation display during a time period (first half of one frame) in which the pixels of blue are displayed, and the pixels of blue are set so as to perform the black gradation display during a time period (latter half of the one frame) in which the pixels of red and green are displayed, the colors of red, green, and blue can be separated completely without being mixed.

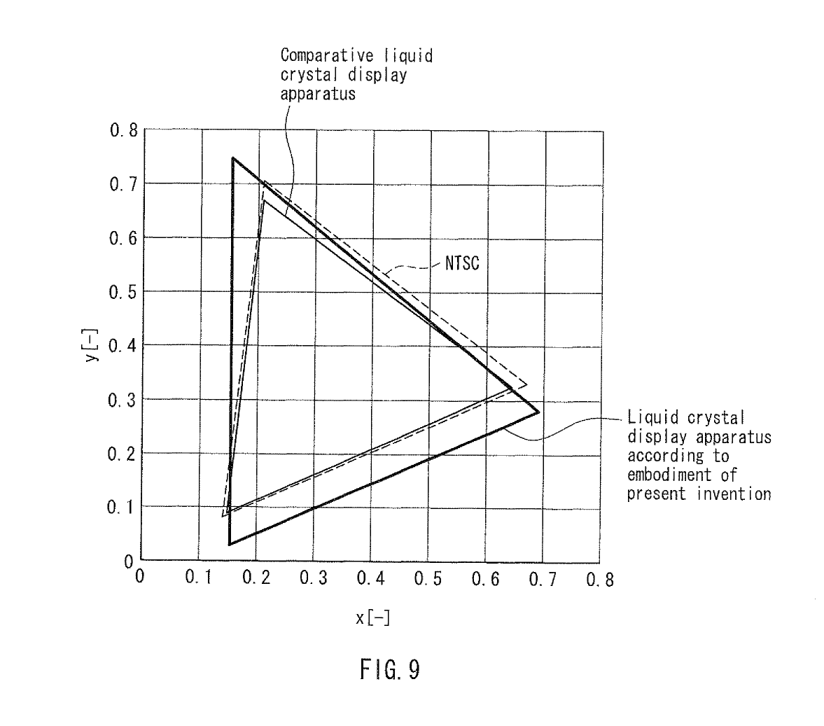

FIG. 9 is a chromaticity diagram (NTSC ratio) showing color reproduction ranges in the CIE 1931 color system of a comparative liquid crystal display apparatus using a three-band tube as a light source for a backlight and the liquid crystal display apparatus 2 of the present embodiment. As the three-band tube used as the light source for the backlight in the comparative liquid crystal display apparatus, a fluorescent tube was used in which a phosphor having an emission spectrum in a wavelength region of green (in the vicinity of 516 nm) (NP-108 manufactured by Nichia Corporation), a phosphor having an emission spectrum in a wavelength region of red (in the vicinity of 611 nm) (NP-340 manufactured by Nichia Corporation), and a phosphor having an emission spectrum in a wavelength region of blue (in the vicinity of 450 nm) (NP-107 manufactured by Nichia Corporation) were sealed.

As can be seen from FIG. 9, as compared with the comparative liquid crystal display apparatus, the liquid crystal display apparatus 2 of the present embodiment exhibited highly improved color purity. As for a NTSC ratio, the conventional liquid crystal display apparatus had a ratio of 87.4%, whereas the liquid crystal display apparatus 2 of the present embodiment had a ratio of 121.3%. Thus, when compared with the comparative liquid crystal display apparatus using the three-band tube or a four-band tube as the light source for the backlight device, the liquid crystal display apparatus 2 of the present embodiment was proved to improve color purity. Further, although a supply of the gate pulse at a cycle of 0.5 frame increases a refreshing rate of a screen, since liquid crystal has a response speed that can conform to the refreshing rate at a frame rate of NTSC, PAL, or the like, the liquid crystal display apparatus 2 of the present embodiment still can be realized sufficiently.

### Second Embodiment

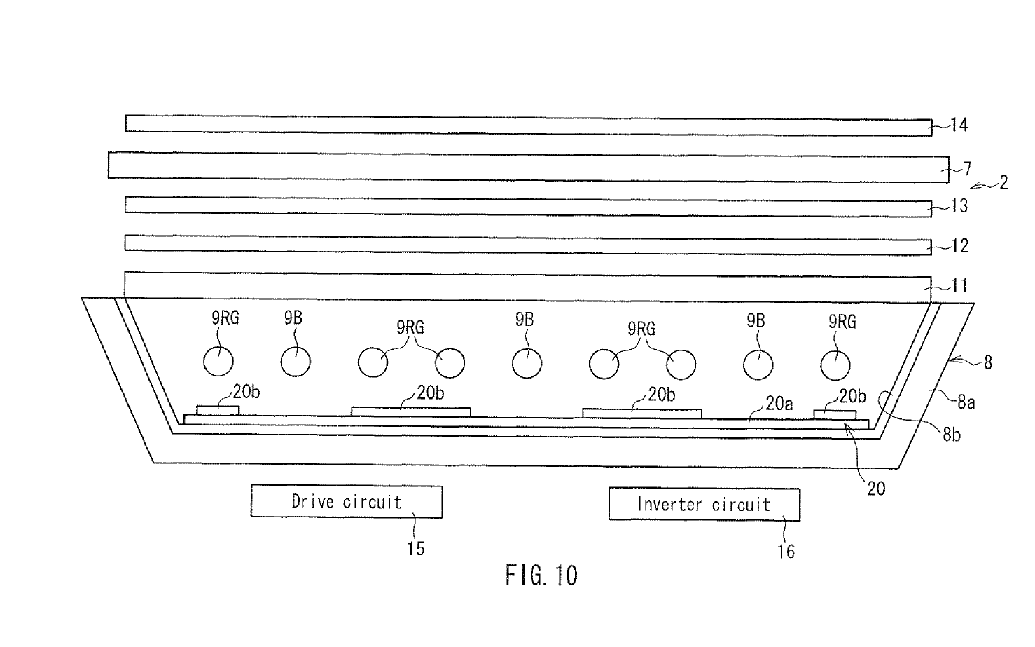

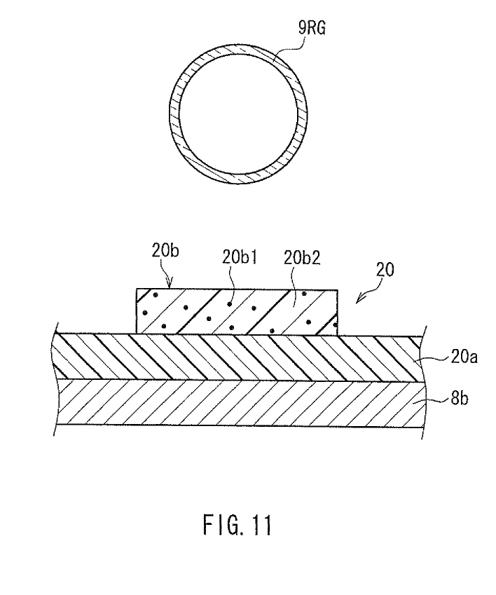

FIG. 10 is a diagram illustrating configurations of main portions of a liquid crystal display apparatus according to a second embodiment of the present invention. FIG. 11 is an enlarged cross-sectional view of a cold cathode fluorescent tube 9RG and a near infrared absorbing filter shown in FIG. 10. In the figures, the main difference of the present embodiment from the first embodiment described above is that the near infrared absorbing filter is disposed on a reflection sheet side. It should be noted that the same elements as those of the first embodiment described above are designated by the same reference numerals and duplicate descriptions of the same are omitted.

As shown in FIG. 10, in a backlight device 8 of the present embodiment, a near infrared absorbing filter 20 as a near infrared absorbing portion is disposed on a surface of a reflection sheet 8b opposed to cold cathode fluorescent tubes 9. As shown also in FIG. 11, the near infrared absorbing filter 20 includes a sheet-shaped base material 20a and a plurality of near infrared absorbing layers 20b formed on a surface of the base material 20a.

The base material 20a is mounted on the surface of the reflection sheet 8b so as to cover an entire bottom surface of the casing 8a. Each of the plurality of near infrared absorbing layers 20b is provided integrally with the base material 20a so as to be opposed to a lower portion (reflection sheet 8b side) of the effective light-emitting portion of the cold cathode fluorescent tube 9RG. Further, each of the near infrared absorbing layers 20b includes absorbing dyes 20b1 that absorb near infrared light, and a binder 20b2 that holds the absorbing dyes 20b1 together.

With the above-described configuration, the backlight device 8 of the present embodiment is capable of having the same functions and achieving the same effects as those of the first embodiment. More specifically, unlike the conventional example as described above, the backlight device 8 of the present embodiment can suppress a near infrared leak and prevent circumferential electrical equipment from being adversely affected by a near infrared noise even when an increased number of the cold cathode fluorescent tubes 9 are provided so as to accommodate a larger screen of a liquid crystal panel 7. Thus, with the backlight device 8 of the present embodiment, a liquid crystal display apparatus 2 that can control a near infrared noise can be formed easily as in the first embodiment.

In the present embodiment, the plurality of near infrared absorbing layers 20b are provided on the surface of the base material 20a so as to correspond to the portions where the cold cathode fluorescent tubes 9RG are provided. Thus, in the present embodiment, even when an increased number of the cold cathode fluorescent tubes 9RG are provided, the near infrared absorbing filter (near infrared absorbing portion) 20 can be incorporated into the backlight device 8 more simply than in the first embodiment.

Besides the configuration as described above, the near infrared absorbing layers 20b may be formed directly on the reflection sheet 8b, which allows the reflection sheet 8b to serve also as the base material 20a.

### Third Embodiment

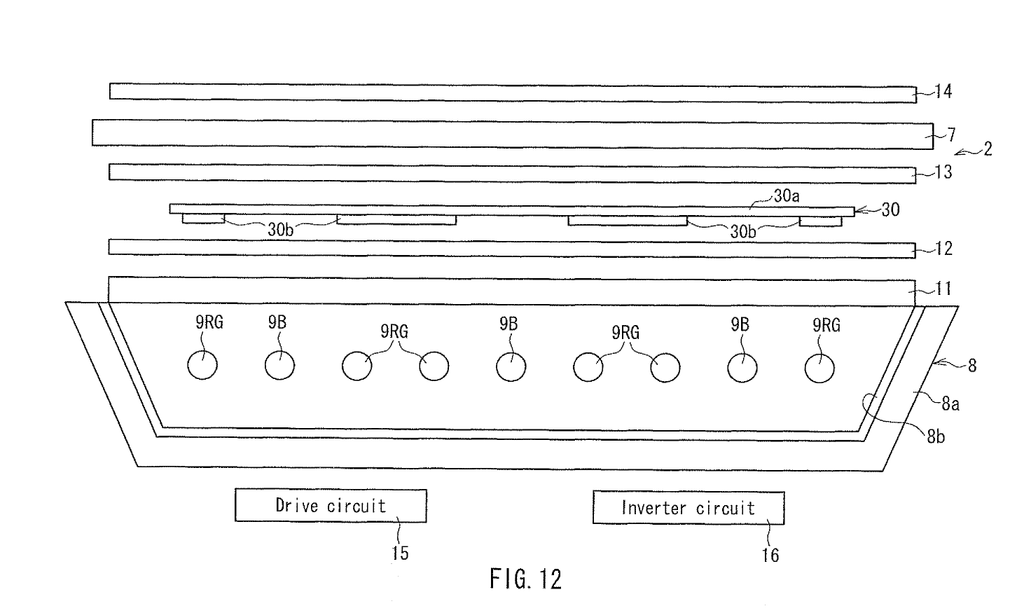

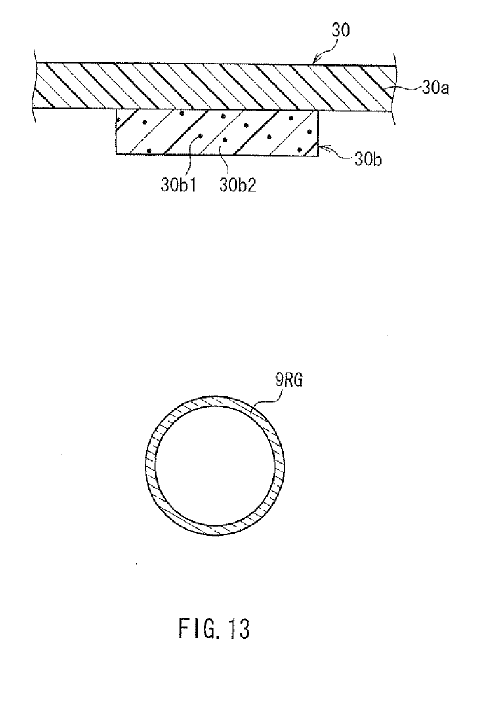

FIG. 12 is a diagram illustrating configurations of main portions of a liquid crystal display apparatus according to a third embodiment of the present invention. FIG. 13 is an enlarged cross-sectional view of a cold cathode fluorescent tube 9RG and a near infrared absorbing filter shown in FIG. 12. In the figures, the main difference of the present embodiment from the first embodiment described above is that the near infrared absorbing filter is disposed on the liquid crystal display side. It should be noted that the same elements as those of the first embodiment described above are designated by the same reference numerals and duplicate descriptions of the same are omitted.

As shown in FIG. 12, in a backlight device 8 of the present embodiment, a near infrared absorbing filter 30 as a near infrared absorbing portion is disposed on the liquid crystal panel 7 side. As shown also in FIG. 13, the near infrared absorbing filter 30 includes a sheet-shaped base material 30a and a plurality of near infrared absorbing layers 30b formed on a surface of the base material 30a.

The base material 30a is provided above the optical sheet 12 and between the optical sheet 12 and the polarizing plate 13. Each of the plurality of near infrared absorbing layers 30b is provided integrally with the base material 30a so as to be opposed to an upper portion (liquid crystal panel 7 side) of the effective light-emitting portion of the cold cathode fluorescent tube 9RG. Further, each of the near infrared absorbing layers 30b includes absorbing dyes 30b1 that absorb near infrared light, and a binder 30b2 that holds the absorbing dyes 30b1 together.

With the above-described configuration, the backlight device 8 of the present embodiment is capable of having the same functions and achieving the same effects as those of the first embodiment. More specifically, unlike the conventional example as described above, the backlight device 8 of the present can suppress a near infrared leak and prevent circumferential electrical equipment from being adversely affected by a near infrared noise even when an increased number of the cold cathode fluorescent tubes 9 are provided so as to accommodate a larger screen of the liquid crystal panel 7. Thus, with the backlight device 8 of the present embodiment, a liquid crystal display apparatus 2 that can control a near infrared noise can be formed easily as in the first embodiment.

In the present embodiment, as in the second embodiment, the plurality of near infrared absorbing layers 30b are provided on the surface of the base material 30a so as to correspond to the portions where the cold cathode fluorescent tubes 9RG are provided. Thus, in the present embodiment, even when an increased number of the cold cathode fluorescent tubes 9RG are provided, the near infrared absorbing filter (near infrared absorbing portion) 30 can be incorporated into the backlight device 8 more simply than in the first embodiment.

Further, in the present embodiment, since the near infrared absorbing filter 30 is provided on the liquid crystal panel 7 side, it is possible to suppress a decrease in the light utilization efficiency of the cold cathode fluorescent tubes 9 and also to suppress a decrease in the brightness of light to the outside, as compared with the cases where the near infrared absorbing filters 10 and 20 are provided in close proximity to the cold cathode fluorescent tubes 9RG.

It should be noted that all the above-described embodiments are illustrative and not limiting. The technical scope of the present invention is specified by the scope of the claims, and any modification falling in the scope of the configuration and equivalent described therein also fall in the technical scope of the present invention.

For example, although the above description explains the cases where the present invention is applied to the transmission-type liquid crystal display apparatus, the backlight device of the present invention is not limited to these cases; the backlight device of the present invention may be applied to various types of display apparatuses each of which has a non-light-emitting type display portion for displaying information such as images and characters by utilizing light from a light source. More specifically, the backlight device of the present invention can suitably be applied to a semi-transmission type liquid crystal display apparatus, or to a projection-type display apparatus in which a liquid crystal panel is used as a light bulb.

Further, besides the above description, the present invention can be used suitably as a film viewer irradiating light to a radiograph, a light box for irradiating light to a picture negative to make it easy to recognize the negative visually, and a backlight device of a light-emitting device that lights up a signboard, an advertisement set on a wall surface in a station, or the like.

Still further, although the above description explains the cases where the cold cathode fluorescent tube is used, the discharge lamp of the present invention is not limited to these cases; another discharge arc tube such as a hot cathode fluorescent tube and a xenon arc tube may be used.

Still further, although the above description explains the cases where the direct type backlight device is used for the backlight portion, an edge-light type backlight device may be applied to the backlight portion.

Still further, the above description explains the cases where the near infrared absorbing filter (near infrared absorbing portion) used includes the absorbing dyes that are at least one of phthalocyanine dyes and diimonium dyes, the binder made of a polyester resin, and the base material made of a polyethylene terephthalate resin. Further, the description explains the cases where the near infrared absorbing filter is provided so as to be opposed to the yellow cold cathode fluorescent tubes.

However, the components of the near infrared absorbing portion such as the absorbing dyes, the binder, and the base material, the respective materials therefor, or the locations where the near infrared absorbing portion is provided, the method of locating the same, and the like are not limited to those described above at all, as long as the near infrared absorbing portion of the present invention is provided so as to be opposed to the discharge lamp of at least one light-emission color among the discharge lamps of a plurality of colors, and absorbs near infrared light emitted from the discharge lamps included in the backlight device.

More specifically, the near infrared absorbing filter may be provided on a surface of the diffusion plate on the cold cathode fluorescent tube side, or may be formed directly on the surface of the diffusion plate, which allows the diffusion plate to serve also as the base material. Further, it is also possible to use a near infrared absorbing portion that includes other absorbing dyes such as azo-based absorbing dyes or naphthalocyanine-based absorbing dyes, or another near infrared absorbing material such as a polycarbonate resin.

Besides the configuration as described above, it is also possible to use discharge lamps that emit light of a plurality of colors mixable into white light, such as two types of discharge lamps that respectively emit light of different colors, one being a type of discharge lamps that emit light of green, and the other being a type of discharge lamps that emit light of red and blue (light of magenta), and three types of discharge lamps of RGB that respectively emit light of red, green, and blue.

However, as in the above-described embodiments, it is preferable to dispose the near infrared absorbing portion at a position that is determined relative to the discharge lamps of a plurality of colors based on its light transmission properties. With this configuration, it is possible to reliably suppress a decrease in the brightness of light from the backlight device to the outside and a variation in the chromaticity of the light due to the provision of the near infrared absorbing portion.

Still further, besides the above description, the configuration may be such that at one of the first half and the latter half of one frame time period, the plurality of first light sources are switched on successively in an order of arrangement so as to be synchronized with an application of the selection signal to each of scanning lines, and at the other of the first half and the latter half of the one frame time period, the plurality of second light sources are switched on successively in an order of arrangement so as to be synchronized with the application of the selection signal to each of the scanning lines. In the case of such a configuration, it is possible to prevent the first light sources and the second light sources arranged in close proximity to each other from emitting light simultaneously, thereby preventing light of the first color and light of the second color from being mixed into each other. Thus, the color purity can be improved further.

### INDUSTRIAL APPLICABILITY

The present invention is useful as a backlight device that can suppress a near infrared leak and prevent circumferential electrical equipment from being adversely affected by a near infrared noise, and a display apparatus using the same.

1. A backlight device comprising:
discharge lamps of a plurality of colors whose light-emission colors are different from each other and that emit light capable of being mixed into white light; and
a near infrared absorbing portion that is provided so as to be opposed to the discharge lamp of at least one light-emission color among the discharge lamps of the plurality of colors, and absorbs near infrared light emitted from the discharge lamp.

2. The backlight device according to claim 1, wherein the near infrared absorbing portion is disposed at a position that is determined relative to the discharge lamps of the plurality of colors based on its light transmission properties.

3. The backlight device according to claim 1,
wherein the discharge lamps of the plurality of colors include a first discharge lamp that emits light containing at least light having a peak wavelength of 650 nm or more, and a second discharge lamp that mainly emits light having a peak wavelength less than 650 nm, and
the near infrared absorbing portion is provided so as to be opposed to the second discharge lamp.

4. The backlight device according to claim 1,
wherein the discharge lamps of the plurality of colors include a third discharge lamp that emits light containing at least light having a peak wavelength of 430 nm or less, and a fourth discharge lamp that mainly emits light having a peak wavelength exceeding 430 nm, and
the near infrared absorbing portion is provided so as to be opposed to the fourth discharge lamp.

5. The backlight device according to claim 1,
wherein the discharge lamps of the plurality of colors include a blue discharge lamp that emits light of blue, and a yellow discharge lamp that emits light of yellow,
the near infrared absorbing portion includes absorbing dyes that are at least one of phthalocyanine dyes and diimonium dyes and absorb near infrared light, a binder that is made of a polyester resin and holds the absorbing dyes together, and a base material that is made of a polyethylene terephthalate resin and supports the absorbing dyes and the binder, and
the near infrared absorbing portion is provided so as to be opposed to the yellow discharge lamp.

6. The backlight device according to claim 1, wherein the near infrared absorbing portion is provided on a side of an object to be irradiated with the light from the discharge lamps.

7. A display apparatus using the backlight device according to claim 1.
